(19) United States
(12) Patent Application Publication
(10) Pub. No.: US 2026/0238964 A1
(43) Pub. Date: Aug. 13, 2026

(54) SYSTEM AND METHOD FOR GROUP-BASED CELLULAR AMBIENT IOT DEVICE AND SERVICE MANAGEMENT

(71) Applicant: Huawei Technologies Co., Ltd., Shenzhen (CN)

(72) Inventors: Zhixian Xiang, Frisco, TX (US); Yunsong Yang, San Diego, CA (US); Kaippallimalil Mathew John, Carrollton, TX (US); Khosrow Tony Saboorian, Plano, TX (US); Abbas Kiani, Vieanna, VA (US)

(21) Appl. No.: 19/631,710

(22) Filed: Mar. 27, 2026

Related U.S. Application Data
(63) Continuation of application No. PCT/US2024/044225, filed on Aug. 28, 2024.
(60) Provisional application No. 63/586,183, filed on Sep. 28, 2023.

(51) Int. Cl. H04W 4/08

(52) U.S. Cl. CPC H04W 4/08

(57) ABSTRACT

According to implementations, a first network function entity receives a first Ambient Internet of Things (AIoT) service request message from an application function entity. The first AIoT service request message includes AIoT operation type indication and group operation indication. The first network function entity constructs a second AIoT service request message based on the first AIoT service request message. The first network function entity sends the second AIoT service request message. The first network function entity receives one or more responses from a group of AIoT devices. The first network function entity sends, to the application function entity, summary information based on the one or more responses from the group of AIoT devices.

### CROSS-REFERENCE TO RELATED APPLICATION

This patent application is a continuation of International Application No. PCT/US 2024/044225, filed on Aug. 28, 2024, and entitled “System and Method for Group-based Cellular Ambient IoT Device and Service Management,” which claims priority to U.S. Provisional Application No. 63/586,183, filed on Sep. 28, 2023, and entitled “New Mechanism for Group-based Cellular Ambient IoT Device and Service Management,” applications of which are hereby incorporated by reference herein as if reproduced in their entirety.

### TECHNICAL FIELD

The present disclosure relates generally to wireless communications, and, in particular embodiments, to methods and apparatus for group-based cellular Ambient IoT Device and Service Management.

### BACKGROUND

In the 4th generation (4G) and 5th (5G) era, various low power wide area (LPWA) technologies, such as enhanced machine type communication (eMTC) and NarrowBand-internet of things (NB-IoT), have been developed to satisfy the increasing demand from verticals (e.g., vertical sectors or industries). These LPWA technologies have achieved low cost, low power, and massive connections and can meet requirements of many applications. However, there are still many use cases and applications that cannot be addressed. For example, conventional battery-powered devices cannot be deployed in extreme environmental conditions (e.g., high pressure, extremely high/low temperature, and/or humid environments). Also, the use of conventional battery devices can be limited where maintenance-free devices are required (e.g., where the devices are inaccessible, and it is not possible/expensive to replace the device battery). Finally, features such as ultra-low complexity, very small device size/form factor (e.g., thickness of mm), and longer life cycle are required for mass market use cases.

### SUMMARY

Technical advantages are generally achieved, by embodiments of this disclosure which describe methods and apparatus.

According to implementations, a first network function entity receives a first Ambient Internet of Things (AIoT) service request message from an application function entity. The first AIoT service request message includes AIoT operation type indication and group operation information. The first network function entity constructs a second AIoT service request message based on the first AIoT service request message. The first network function entity sends the second AIoT service request message. The first network function entity receives responses from a group of AIoT devices. The first network function entity sends, to the application function entity, summary information based on the responses from the group of AIoT devices.

In some implementations, the first network function entity may be a separate network function from an access management function (AMF) entity.

In some implementations, the first network function entity may send, to an AIoT reader, the second AIoT service request message.

In some implementations, the first network function entity may be a part of an AMF entity.

In some implementations, the AIoT operation type indication may indicate at least one of an AIoT data collection operation, an AIoT inventory management operation, an AIoT position operation, or an AIoT command operation.

In some implementations, the responses may include a first response from a first AIoT device of the group of AIoT devices. The first response may include first AIoT device identity information. The first AIoT device identity information may indicate at least one of a device identity (ID) of the first AIoT device, a group ID identifying the group, a network ID, a service provider ID, an AIoT dynamic ID, an AIoT device type, or an AIoT capability.

In some implementations, the responses may include a first response from a first AIoT device of the group of AIoT devices. The first response may indicate at least one of a security key or a hash compression code.

In some implementations, the first AIoT service request message may further include AIoT service request area information and AIoT service time information.

In some implementations, the AIoT service time information may further indicate at least one of a start time and an end time of an inventory query operation, a frequency of the inventory query operation, other time restriction and information associated with an AIoT service or an AIoT operation, or an aggregation waiting time for collecting responses from AIoT devices within a group for each AIoT operation.

In some implementations, the second AIoT service request message may further indicate a cell ID or a tracking area.

In some implementations, the summary information may be aggregated from the responses about a group of AIoT devices. The summary information may be sent to the application function entity in a single response message.

In some implementations, the first AIoT service request message, the second AIoT service request message, and the responses may be conveyed through an AMF using control plane management messages.

According to implementations, an AIoT device receives, from an AIoT reader, a radio signal including an AIoT operation instruction and a group ID. The AIoT device maps an assigned and stored group ID of the AIoT device to the group ID. The AIoT device conducts an operation according to the AIoT operation instruction. The AIoT device sends, to the AIoT reader, a response including identity information of the AIoT device.

In some implementations, the response may further include status information.

In some implementations, the AIoT operation instruction may indicate at least one of an AIoT data collection operation, an AIoT inventory management operation, an AIoT position operation, or an AIoT command operation.

In some implementations, the identity information may indicate at least one of a device identity (ID) of the AIoT device, the group ID, a network ID, a service provider ID, an AIoT dynamic ID, an AIoT device type, or an AIoT capability.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates the Gen2 tag memory map;

FIG. 2 shows an example network system architecture of using AIoTMF, according to some implementations;

FIG. 3 shows an example of AIoT device identity information, according to some implementations;

FIG. 4 shows an example of inventory Tags being organized into different groups, according to some implementations;

FIG. 5 shows an example flow diagram for a procedure of the AIoT group inventory service for known and targeted group, according to some implementations;

FIG. 6 shows an example flow diagram for a procedure of the AIoT group inventory service for unknown group members within a certain location, according to some implementations;

FIG. 7 shows an example flow diagram for a procedure for commanding one group of AIoT devices for a certain operation, according to some implementations;

FIG. 8 shows an example flow diagram for operations performed by an AIoT device, according to some implementations;

FIG. 9A shows a flow chart of a method performed by a first network function entity, according to some implementations;

FIG. 9B shows a flow chart of a method performed by an AIoT device, according to some implementations;

FIG. 10 illustrates an example communications system, according to some implementations;

FIG. 11 illustrates an example communication system, according to some implementations;

FIGS. 12A and 12B illustrate example devices that may implement the methods and teachings of this disclosure, according to some implementations; and

FIG. 13 shows a block diagram of a computing system that may be used for implementing the devices and methods disclosed herein, according to some implementations.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Ambient power-enabled IoT is a promising technology to fulfil the unmet market requirements stated above. An Ambient power-enabled IoT device is an IoT device powered by energy harvesting, being either battery-less or with limited energy storage capability (e.g., using a capacitor), and the energy is provided through the harvesting of radio waves, light, motion, heat, or any other suitable power source. The 3rd Generation Partnership Project (3GPP) has started the work to define the 5G standard in support of Ambient IoT devices with lower complexity, smaller size, reduced capabilities, and lower power consumption than previously defined 3GPP IoT devices (e.g., NB-IoT/eMTC devices) with an emphasis on improving network efficiency. 3GPP Service and System Aspects (SA)1 Working Group (WG) has completed a study on the use cases and service requirements for Ambient IoT (TR22.840). 3GPP radio access network (RAN) WGs are also conducting a study on a new air-interface for Ambient IoT, while 3GPP SA2 WG is discussing the creation of a new study item on the enhanced 5G core network to support Ambient IoT based on the defined requirements from 3GPP SA1.

3GPP is considering defining 3 types of Ambient IoT devices:
Passive (Device A): a device with no energy storage, no independent signal generation/amplification (e.g., using backscattering transmission instead).
Semi-passive (Device B): a device that has energy storage, no independent signal generation (e.g., using backscattering transmission). The device's use of stored energy can include amplification of reflected signals.
Active (Device C): a device that has energy storage, has independent signal generation (e.g., active RF components for transmission).

3GPP is also considering defining the following 4 types of AIoT services to be supported by 3GPP standardization:
Inventory: using an Ambient IoT device for inventory management.
Sensors: using Ambient IoT devices to collect the data from the sensors.
Positioning: providing positioning service for an Ambient IoT device.
Command: Triggering an Ambient IoT device to conduct certain operations.

There are some existing non-cellular-based Ambient IoT standards, such as radio frequency identification (RFID) electronic product Code (EPC) second generation (Gen2), which is the standard for one of most popular Ambient IoT technologies. The RFID EPC technology only supports passive Ambient IoT devices, such as type A and B devices as defined in 3GPP. These RFID EPC devices operate on a frequency range from 860-960 MHz. An RFID device can support three basic operations:
a) Selection: choosing a Tag population. An interrogator may use a Selection command to select one or more Tags based on a value or values in the Tag memory, and may use a Challenge command to challenge one or more Tags based on Tag support for the desired cryptographic suite and authentication type.
b) Inventory: identifying individual Tags. An interrogator begins an inventory round by transmitting a Query command in one of four sessions. One or more Tags may reply. The Interrogator detects a single Tag reply and requests the Tag's EPC. Inventory comprises multiple commands. An inventory round operates in one and only one session at a time.
c) Access: communicating with an identified Tag. The interrogator may perform a core operation such as reading, writing, locking, or killing the Tag; a security-related operation such as authenticating the Tag; or a file-related operation such as opening a particular file in the Tag's User memory. Access comprises multiple commands. An interrogator may only access a uniquely identified Tag.

The selection and inventory operations of the RFID EPC can be similar to the inventory service proposed by the 3GPP Ambient IoT work, and the Access operation RFID EPC can be similar to the command services proposed by 3GPP Ambient IoT work. The sensor and positioning services are new services which are not supported by RFID EPC.

Because Ambient IoT devices can be very small and low cost, the number of devices deployed can be very large in certain area(s). For, example, for inventory or asset management scenarios, the device density can be less than 1.5 million/km², and there can be less than 5200 devices/km² for outdoor logistic sensor data collection. Therefore, how to efficiently manage such large numbers of Ambient IoT devices needs to be considered when developing 5G Ambient IoT technology. The existing Ambient IoT technologies, such as RFID EPC Gen2, manage Ambient IoT devices individually using contention-based solutions. In doing so, managing a massive number of devices individually will take longer time and consume more energy and resources from the network.

One of the advantages of a cellular-based Ambient IoT solution compared to the existing technology is that communication resources can be better organized and managed by a cellular-based solution. Therefore, implementing a mechanism, which can manage the Ambient IoT devices in an organized manner, can be feasible, such as grouping similar devices together and conducting bulk operations on those grouped devices with assigned network resources.

RFID EPC Gen2 only supports operating and managing an AIoT device individually but not multiple devices simultaneously as a group. Therefore, RFID EPC Gen2 does not support bulk operations for a group of devices which share similar characteristics. A network or the AIoT service operator may prefer to conduct certain operations on AIoT devices at the same time (Note, the device within the group will respond to the group command individually, but network can coordinate the response and provide a comprehensive response based on those individual responses to the service provider). The RFID EPC standard defines two grouping IDs in its data standard:
Global Identification Number for Consignment (GINC). This number is only used to assign a unique identity to a logical grouping of goods (one or more physical entities) that has been consigned to a freight forwarder and is intended to be transported as a whole.
Global Shipment Identification Number (GSIN). The Global Shipment Identification Number EPC scheme is used to assign a unique identity to a logical grouping of logistic units for the purpose of a transport shipment from that consignor (seller) to the consignee (buyer).

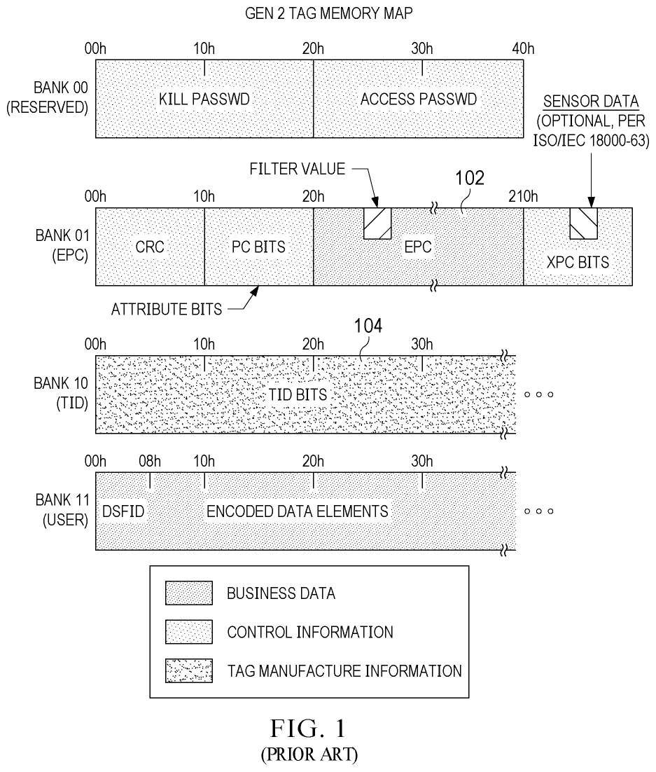

But these two group IDs are for business purposes but not for device operation with the network or reader, as those IDs will be stored and used in the EPC filter value field 102 shown in FIG. 1. These IDs are not used for operations between tag and reader as defined in the standard. And the TID (Tag Identity) (shown in field 104 in FIG. 1), which is used for interactions between Tag and reader, does not contain the group ID in the existing standard.

Also, the two group IDs (GINC and GSIN) defined in EPC are restricted to the same shipment. But for an AIoT deployment, there can be different ways to organize the AIoT devices into different groups and operate them by groups (e.g., different products within the same location can be put into a group, or different products with similar security protection(s) can be grouped together). Those dynamic grouping mechanisms are not considered in the current RFID EPC standard.

Further, the RFID EPC standard has limited support for the AIoT device being used in a network environment, because, once a reader accumulates information, the reader can pass the information to some application without needing a network. Therefore, there is no network ID or network service provider ID defined, and there is no network relationship support in the current standard. A network based solution can provide one approach that couples the reader's response to an application interface. Moreover, the RFID EPC standard only defines the standard between an AIoT device (e.g., Tag) and the reader, but there is no standard on how a network handles the AIoT devices and the AIoT service if the reader is an access node of the network.

3GPP has developed some grouping management mechanisms for IoT devices, but these grouping mechanisms cannot be used for Ambient IoT. For example, the existing MTC grouping uses a virtual network (VN) grouping mechanism which requires establishing a PDU session for each IoT device. It is anticipated that there will be no PDU session established for each Ambient IoT device. Further, most Ambient IoT communications are short transaction based, which means that an AIoT device may be able to conduct 1-3 interactions with a reader for single service tasks.

In addition, per the existing 3GPP IoT related standards, all IoT devices are still independent user equipments (UEs) but with limited capability. These IoT devices use a similar identity mechanism and definition like normal 3GPP UEs. It is expected that for an AIoT device, there will be a new 3GPP device type because of its extreme simple implementation and very limited transmission power. Therefore, the identity of a 3GPP AIoT device needs to be redefined. The new AIoT ID information needs not only support the grouping operation, but also be flexible enough to support various network deployments using minimum interactions with the network, such as working with different network providers which may support different capabilities.

Because the 3GPP AIoT device is a new type of device with minimum interactions with the network, the coordination between network functions within the 3GPP system to handle the AIoT device can be different compared to the conventional 3GPP UE. Some differences include a dedicated network function which interacts with other network functions (NFs) on behalf of AIoT device, and new messages and interactions between NFs are desired.

The existing RFID readers can connect to a finite number of devices. There is no group device management within the RFID readers. Typically, a custom application is needed for group management for RFID EPC standard. A cellular system is standardized and supports group management and interfacing to an application interface. The existing non-3GPP based ambient IoT solution cannot handle this massive quantity of ambient IoT devices, and currently there are no group-based device management and operation. However, specific solutions for cellular Ambient-IoT group management are desired.

This disclosure describes mechanisms that manage and operate a large number of cellular based Ambient IoT devices by organizing these devices in different groups, including Ambient IoT device group identification, registration, detection, discovery, and triggering.

Compared to existing IoT devices defined in the current 3GPP standard, such as NB-IoT and eMTC, an Ambient IoT device can be different in many ways:
An Ambient IoT device is a simple device that is unable to produce power by itself but relies on energy harvesting from other sources. The device Ambient IoT device cannot perform many self-initiated tasks that a traditional UE defined in the 3GPP standard can perform.
Due to the Ambient IoT device's extreme simplicity and power limitation, AIoT device management (e.g. trigger, write, read, and/or kill operations) may be performed in the network or in a UE, such as an Ambient IoT reader that acts as a proxy on behalf of the AIoT service provider or application provider.
Due to the Ambient IoT device's extreme simplicity, the interaction between the AIoT device and the network is desired to be minimal; therefore, the AIoT device may not interact with many NFs like an existing cellular IoT device does. It is desirable to have only one NF (e.g., a gNB or a UE as the AIoT reader) to interact with the Ambient IoT device.

This disclosure includes a new Ambient IoT Management Function (AIoTMF) which is responsible for interacting with the Ambient IoT device (via a gNB or a UE as the Ambient IoT reader) and other Network Functions to manage the connectivity and Ambient IoT service(s) of cellular connected Ambient IoT devices, including:
interacting with an AIoT service provider's application function (AF) for Tag management (e.g., discovery, access, security, service trigger, and/or mobility), and translating the service request from the AF to cellular internal service requests to other Network Function(s) to conduct Ambient IoT operation(s) within cellular network system;
Ambient IoT device group management, including group creation/modification/termination;
potential interaction with a UE-based AIoT reader which uses other non-3GPP radio access technology (RAT) technologies;
Ambient IoT user data retrieval and forwarding to the AF, include charging capability;
RAN and AIoT reader selection, which can be based on the location of the Ambient IoT device, or other selection policy.

The AIoTMF can be implemented and deployed as an individual network function, or it can be implemented as part of the access management function (AMF) or other suitable network function.

This disclosure provides a control plane-based architecture which allows Ambient IoT user data to be exchanged between Ambient IoT device and its application server (AIoT service server) via the control plane of 5G network.

The technical considerations of using the control plane can including the following.
AIoT user data has very small size (per tag data: uplink (UL) data is usually less than 100 bytes, normally around 128 bits; downlink (DL) data can be much smaller, mainly device configuration). In addition, it is expected that AIoT user data transmission is very infrequent. So using a network resource to establish a dedicated user plane (e.g., a protocol data unit PDU session) may not be cost efficient to the network.
Because AIoT user data and command data are closely coupled and normally transmitted together, it is desirable to use the control plane.
The existing standardized NB-IoT architecture may be reused, which allows the user data to be transferred over the control plane.
Because an AIoT device is not a normal cellular UE, a UE-based PDU session may not be needed.

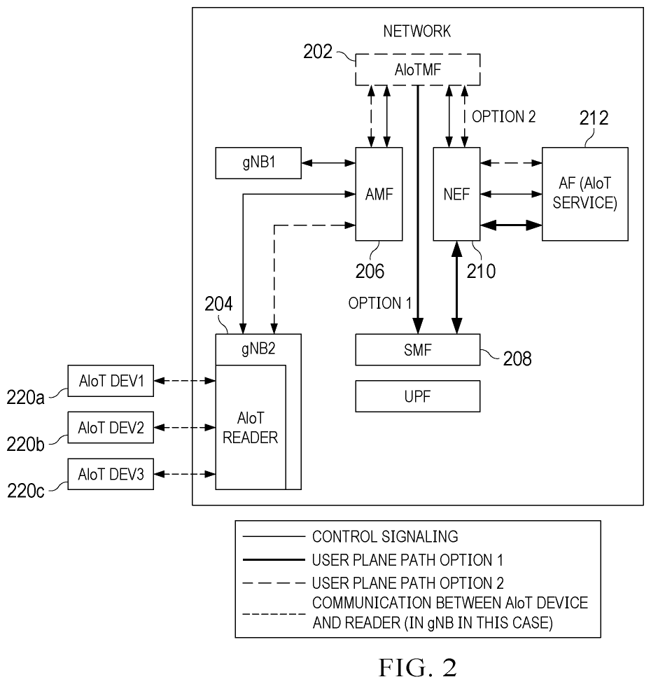

As shown in FIG. 2, there can be two options for AIoT user data being transferred using the control plane.

With option 1, after the AIoT user data is transmitted from the Ambient IoT device (e.g., 220a, 220b, 220c) to the gNB 204, the gNB 204 sends the AIoT user data to the AMF 206 which then forwards the AIoT user data to the AIoTMF 202. The AIoTMF 202 forwards the AIoT user data to the session management function (SMF) 208, which is the user plane control function, to deliver the AIoT user data to the AF 212 via the network exposure function (NEF) 210.

With option 2, after the AIoT user data is transmitted from the Ambient IoT device (e.g., 220a, 220b, 220c) to the gNB 204, the gNB 204 sends the AIoT user data to the AMF 206, which then forwards the AIoT user data to the AIoTMF 202. The AIoTMF 202 may directly forwards the AIoT user data to the AF 212 via the NEF 210.

The AIoT user data can be bi-directionally transferred via the control plane (both uplink and downlink), while most of the use cases utilize AIoT user data being transferred in the uplink direction. There are some downlink example use cases, where the network provides the downlink AIoT user data, such as data for provisioning the AIoT device or conducting a write command to input some user data to the AIoT device.

An AIoT reader agent can be a UE acting as an Ambient IoT reader and interacts with AIoTMF for Ambient IoT device management.

In some example implementations, either the gNB or the UE can be the AIoT reader to directly interact with AIoT device(s).

In order for the network or the application to uniquely identify the Ambient IoT device and manage the Ambient IoT device based on its identity, an implementation for an Ambient IoT device identity (ID) information is provided. This identity information can be stored and configured in the Ambient IoT device. This identity information can be provided by the AIoT service provider to the network or the Ambient IoT reader to identify the Ambient IoT device for every transaction between the AIoT device and the network/AIoT reader. The AIoT device can store the AIoT ID information. The AIoT ID information stored in the AIoT device can be configured/provisioned by the network via configuration command(s) to update the identity information.

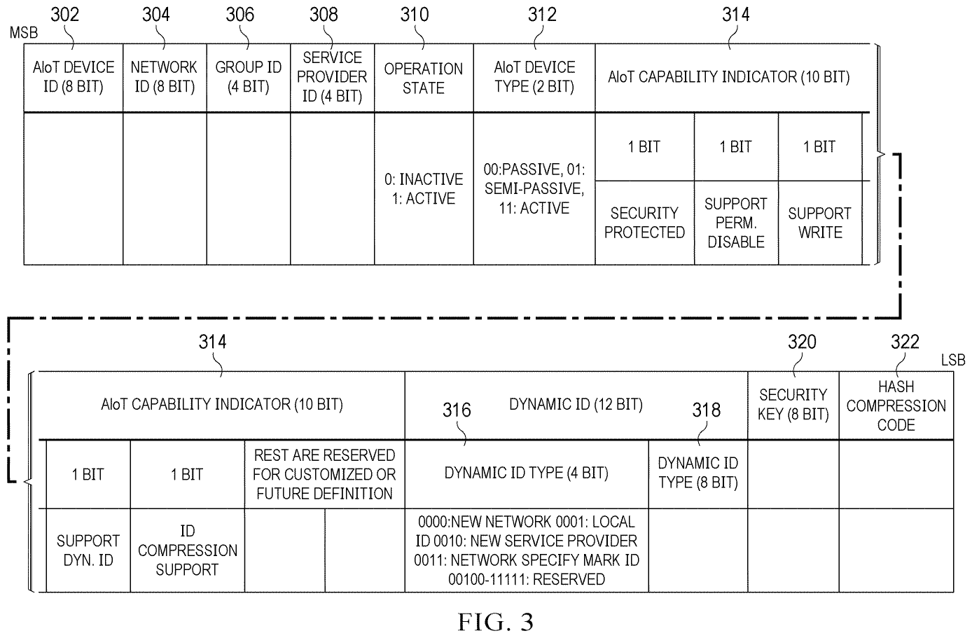

The AIoT device identity information may include the following information elements (one or more fields can be optional), which are also illustrated in an example of Ambient IoT identity information structure in FIG. 3. The AIoT device identity information.
AIoT device unique identity (ID) (e.g., field 302): This ID can be used to uniquely identify an AIoT device within a certain domain, such as per network, per location, and/or per group. This unique ID can be determined and assigned by an AIoT service provider who owns or manages the AIoT device.
Network ID (e.g., field 304): This ID identifies the network to which an AIoT device belongs with a business contract (e.g., subscription). The Network ID can be a Public Line Mobile Network (PLMN) ID or a private network ID.
Group ID (e.g., field 306): This ID identifies the group to which an AIoT device belongs. The group can be organized and managed by the service owner of the AIoT devices. The AIoT devices can be grouped based on different service types (e.g., inventory, sensor), device type (e.g., passive, semi-passive, or active), device administrative domains, or the commercial objects or sensor(s) to which the AIoT devices are attached, or other business reasons. The Group ID can assigned by the service owner.
   The group ID can be dynamically defined and provided to a cellular network by the AF. When the group ID is changed, the AF provides a new group ID and a possible updated operation policy to the cellular network.
AIoT device type (e.g., field 312): The device types can be passive, semi-passive, or active.
AIoT capability indicator (e.g., field 314): This indicator can be a bit mask for different capabilities being supported or not supported by an AIoT device. Each bit of the bit mask can indicate one capability of the AIoT device. Examples of the capability can include: support of security protection; support of a kill command to disable RF transmission capability; support of certain optional commands sent by the network or reader; and support of a dynamic ID.
Service provider (or owner) ID (e.g., field 308): This ID identifies the service provider of an AIoT device which uses the AIoT device to provide service(s). The service provider can also be the owner of the AIoT device by owning the credential of the AIoT device.
Operation state (e.g., field 310): This field indicates the operation state of the AIoT device (e.g., inactive or active).
AIoT dynamic ID (e.g., field 318): This is an ID field which can be dynamically changed based on different deployment scenarios, such as new roaming network ID or new Cell ID, when the AIoT device is moved to this network or Cell.
Dynamic ID type (e.g., field 316): This field can be a bit mask, and each bit may indicate the type of dynamic ID is used:
   new network ID: this network ID can identify the roaming partner of the home network or a visited network with which the AIoT device is associating currently;
   new location ID: this ID is a re-agreed area ID which presents a location block;
   AIoT service provider ID: this field is the ID of the service provider who uses the AIoT device;
   network specified mark ID: this field is an ID specified by network or service provider to mark the AIoT devices for special purposes which may require special treatment;
   Other reserved dynamic ID.
Optional security key (e.g., field 320): This may be a private key for security protection.
Hash compression code (e.g., field 322): Because of very limited member storage and transmission power, the identity information can be compressed, stored and transmitted with this hash compression code.

The AIoT device identity information, such as the information shown in FIG. 3, can be provided by the AIoT service provider to the network or the Ambient IoT reader. The actual size of each information element and the order of their arrangement in the ID structure in the final standard may be different than the example shown in FIG. 3.

Many ambient IoT use cases defined by 3GPP SA1 [TR22.840] are related to one or multiple groups of AIoT devices. Devices in a group share similar characteristics with other devices within the group, such as a same type of devices, providing a same service, and so on. Typically, the AIoT service providers collect data from the AIoT devices within the group at the same time or small window of time. Therefore, instead of operating each AIoT device individually, grouping the AIoT devices together and conducting group-based operations can make system operation(s) more efficient, as well as reducing network and AIoT devices'energy consumption. Implementations of group based Ambient IoT device and service management are provided in this disclosure.

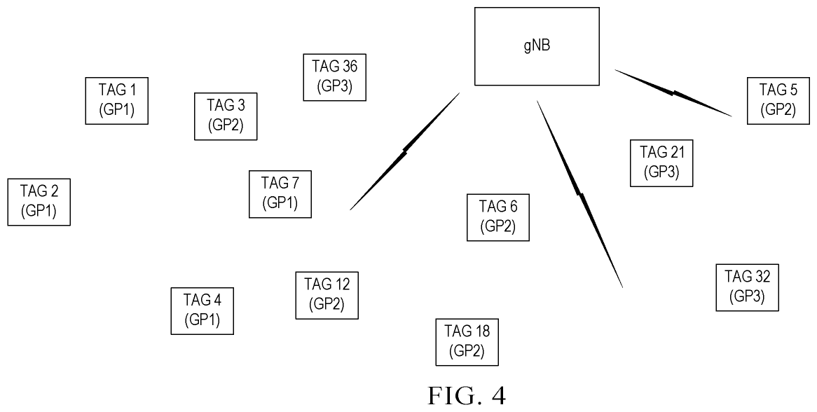

FIG. 4 shows an example of inventory Tags being organized into different groups, according to some implementations. In FIG. 4, the Tags represent AIoT devices, and each pattern represents a different group (e.g., gp1, gp2, and gp3).

The RFID EPC standard defines some operations and commands being used for the interaction between the AIoT device and the AIoT reader, but there are no standards or solutions defined on the interactions between an AIoT service provider/owner and the network which provides the AIoT connectivity service, as well as the interaction(s) within a network system to manage the AIoT devices. Also, the operations or commands applied to AIoT devices may not be executed immediately or unconditionally, but can be associated with certain conditions, such as time, location, or criteria. But there are validity condition(s) and restriction(s) on the commands and operations considered in the RFID EPC standard. The embodiments include group-based operations with new control messages and the new group-based information elements being conveyed using those control messages between AIoT devices and different network functions. The new AIoT control messages can include:
1. AIoT service request and response messages between the AF and the AIoTMF via the NEF.
   The AIoT service request message can be used to exchange an AIoT service request from a third-party AIoT service provider to the AIoTMF, while the AIoT service response message can be used by the AIoTMF to provide feedback on the AIoT operation requested by the AIoT service provider. Within this type of control messages, some information elements, which of some are for group operation, are provided below.
      a. AIoT operation type indication: This indication can indicate the operation type requested by the AIoT service provider. Some operations type can be:
         i. Inventory query service: inventory query of the AIoT device(s). This operation type can query an individual AIoT device or one or more group of AIoT devices.
         ii. Sensor data collection. This operation type cam collect (read) the sensing data stored in the AIoT device which is also a sensor.
         iii. AIoT position request. This operation type can request the position of the AIoT device(s).
         iv. Operation commands to AIoT device: This operation type can send some operation commands to AIoT device(s), to trigger the AIoT device(s) to conduct some operations, such as: write data, permanently or temporarily disable its RF transmission, permanently or temporarily block memory access of the AIoT device(s). The definition of some of the operations can be similar with what have defined in RFID EPC standard but the implementation can be different for cellular AIoT to adapt to the cellular radio access technologies.
      b. Group operation indication: This indication can indicate whether the service request is for individual AIoT devices or for a certain group of AIoT devices. This indication can be used to indicate whether bulk operation for one or more group(s) of devices is expected.
      c. AIoT service request area: This indication can indicate the interested area by AIoT service provider where the service request is aimed to. The definition of the area can be decided by the network operator and the AIoT service provider, and the network operator can map the AIoT service area to the network area which is used in communication within mobile network, such as a tracking area or an interesting area.
      d. AIoT service time: This field can define the validity of the time for the requested AIoT service. This time validity information can include the start or the end of the AIoT service operation, the frequency and interval of the AIoT service time, the duration of the AIoT service operation, or other time restriction and information associated with the AIoT service and operation.
2. AIoT service request and response messages between the AIoTMF and the RAN or the AIoT reader. Those messages may be conveyed through the AMF because the AMF is acting as gateway between the RAN and the 5G core (5GC_. Based on the service request from AIoT service provider, the AIoTMF constructs the cellular network internal service request message to AIoT reader which can be a gNB or a UE. The similar information element introduced in #1 (AIoT service request and response messages between the AF and the AIoTMF via the NEF) above can be also used in the message here except that the AIoT service request area is the area defined in the cellular network, such as track area or cell ID, or other area definition which understood by the gNB or the UE.
3. AIoT control signal between AIoT reader (gNB or UE). This control signal is from the AIoT reader (gNB or UE) to the AIoT device. This control signal can include query group ID, operation type indication, etc. The signal from the AIoT device to the AIoT reader can include the AIoT device ID information as described with respect to FIG. 3 above.

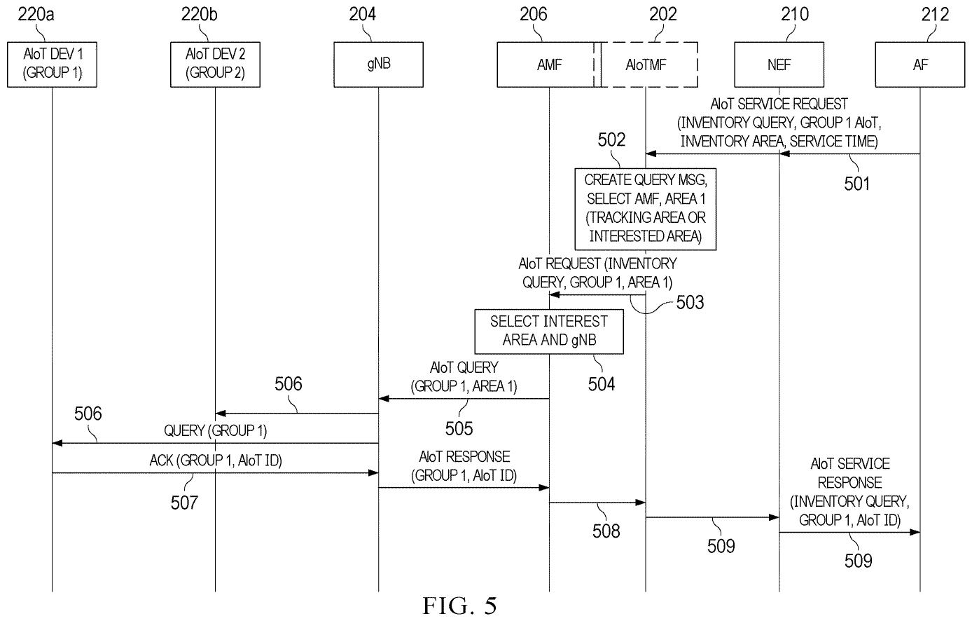

FIG. 5 shows an example flow diagram for the procedure of the AIoT group inventory service for known and targeted group, according to some implementations. This procedure introduces a mechanism to allow the network or AIoT service provider to conduct the inventory service for checking the status of a group of AIoT devices in a certain area. This procedure describes a broadcast/multicast mechanism in which the AIoT reader (UE or gNB) broadcasts/multicasts a message containing one or more group IDs for the inventory service within one or multiple target area(s). After receiving the message, an AIoT device having the particular group ID (or within the requested group) can respond with its ID information. The reception of the message can allow the AIoT device to respond using backscattering. The AIoT reader and the cellular core network prepares and coordinates the pre-allocated network resource to collect the multiple responses from all the AIoT devices within the query group(s) at the same time or in a small time window. After the cellular core network receives the responses from the group of devices, the core network can aggregate the responses and provide a single response to the AIoT service provider. The single response can include the summary information of that group of devices.

At the operation 501, the AIoT service provider wants to perform an inventory-check on a group of items (e.g., group 1) in a location. The AIoT service provider's AF 212 sends an AIoT service request message with an inventory query indication to the AIoTMF 202 via the NEF 210, which acts as the 5G network exposure function interface to the application outside the 5G system. The AIoT service request message may include: the inventory query indicator, the group operation indication, the queried group ID (e.g., group 1), the inventory query area, and/or the time window for inventory query start. The inventory query time information can also include the frequency (e.g., periodicity) of the inventory query, and/or the start and the end time of the inventory query operation.

At the operation 502, after the AIoTMF 202 receives the AIoT service request message, the AIoTMF 202 conducts area mapping from the inventory area provided by the AF 212 to the tracking area or the interested area defined within the 5G system. The AIoTMF 202 then identifies and selects the AMF(s) (e.g., AMF 206) which is(are) responsible for the inventory query.

At the operation 503, when the inventory window starts, the AIoTMF 202 sends a 3GPP internal AIoT service message to the selected AMF(s) (e.g., AMF 206) with the group query indication as group ID (e.g., 1) information, and/or tracking area(s) or interested area information for the inventory service.

At the operation 504, the AMF 206 selects the appropriate gNB 204 for the inventory area.

At the operation 505, the AMF 206 forwards the AIoT service request message to the appropriate gNB 204 with a group AIoT query indication.

At the operation 506, with the group query indication, the gNB 204 sends broadcast/multicast message with the inventory group 1 query.

At the operation 507, the AIoT device 220a, whose group 1 ID matches with the group ID in the message, responds (e.g., backscatters) with its ID information including status information. The gNB 204 collects the responses from group 1 AIoT devices (e.g., device 220) and forwards them to the AMF 206. The ID information may include the same information as AIoT device identity information illustrated in FIG. 3, and the status information may be operation state 310.

At the operation 508, the AMF 206 sends the AIoT response message to the AIoTMF 202.

At the operation 509, the AIoTMF 202 collects all the response data from the AIoT devices belonging to group 1. The collection operation may require the AIoTMF to wait for a certain period of time to get all the responses. The AIoTMF 202 further sends the AIoT service response back to the AF 212 via the NEF 210 with the ID information of all responding AIoT devices which belong to group 1.

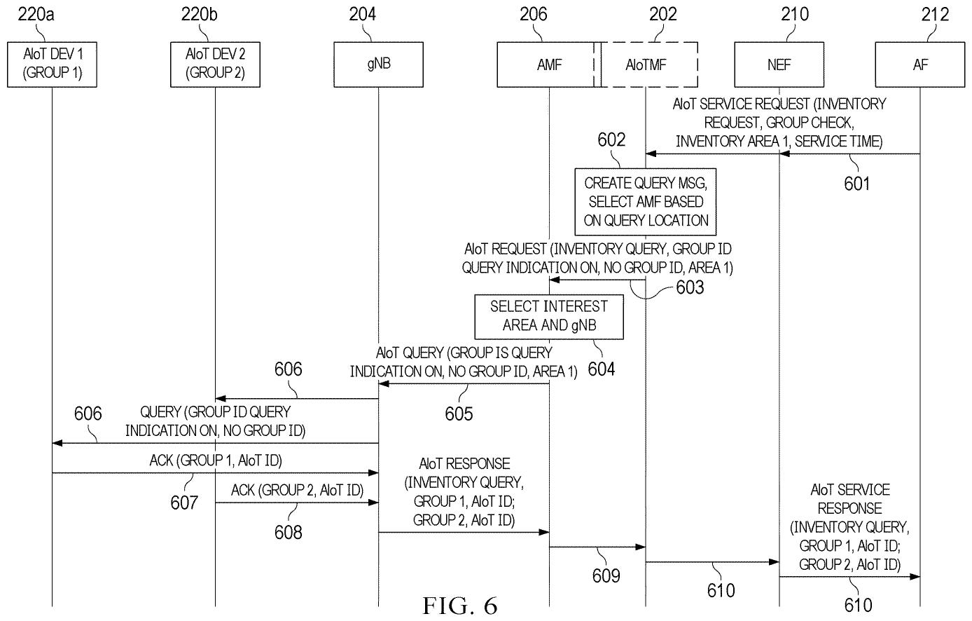

FIG. 6 shows an example flow diagram for a procedure of the AIoT group inventory service for unknown group members within a certain location, according to some implementations. This inventory service is to check whether there is new group member of the AIoT devices present in a certain area, or to survey how many groups of AIoT devices are in the certain area.

At the operation 601, the AIoT service provider wants to perform an inventory check on how many items are at one location (e.g., within an inventory area) and to which group they belong. The AIoT service provider's AF 212 sends an AIoT service request message to the AIoTMF 202 via the NEF 210, which acts as the 5G network exposure function interface to the application outside the 5G system. The inventory request message may include: the AIoT inventory query indication, the group operation indication but without the group ID, the inventory query area, and/or the time window for inventory query start. The inventory query time information can also include frequency (e.g., periodicity) of the inventory query, and/or the start and end time of inventory query operation.

At the operation 602, after the AIoTMF 202 receives the AIoT service request message, the AIoTMF 202 conducts area mapping from the inventory area provided by the AF 212 to the tracking area or the interested area defined within the 5G system. The AIoTMF 202 then identifies and selects the AMF(s) (e.g., AMF 206) which is(are) responsible for the inventory query.

At the operation 603, when the inventory window starts, if there is a starting time, the AIoTMF 202 sends a 3GPP internal AIoT service request message to the selected AMF(s) (e.g., AMF 206) with the group query indication without the group ID information, tracking area, or interested area information.

At the operation 604, the AMF 206 selects the appropriate gNB(s) (e.g., gNB 204) for the inventory area.

At the operation 605, the AMF 206 forwards the AIoT service request message to the gNB(s) (e.g., gNB 204) with a group AIoT query indication.

At the operation 606, with the group query indication, the gNB 204 sends a broadcast/multicast message for the inventory group query without specific group ID information.

At the operation 607, the AIoT device 220a responds (e.g., backscatters) with its ID information including its group ID and status information. The gNB 204 collects the responses from the group 1 AIoT devices within the area and forwards them to the AMF 206. The ID information may include the same information as AIoT device identity information illustrated in FIG. 3, and the status information may be operation state 310.

At the operation 608, the AIoT device 220b responds (e.g., backscatters) with its ID information including its group ID and status information. The gNB 204 collects the responses from the group 2 AIoT devices and forwards the responses or sends one aggregated AIoT response to the AMF 206.

At the operation 609, the AMF 206 sends the AIoT service response messages received from the gNB 204 to the AIoTMF 202.

At the operation 610, the AIoTMF 202 collects all the response data from the AIoT devices. This operation may require the AIoTMF 202 to wait for a certain period of time to get all the responses. Then the AIoTMF 202 sends the AIoT service response back to the AF 212 via the NEF 210 with the ID information of all responding AIoT devices.

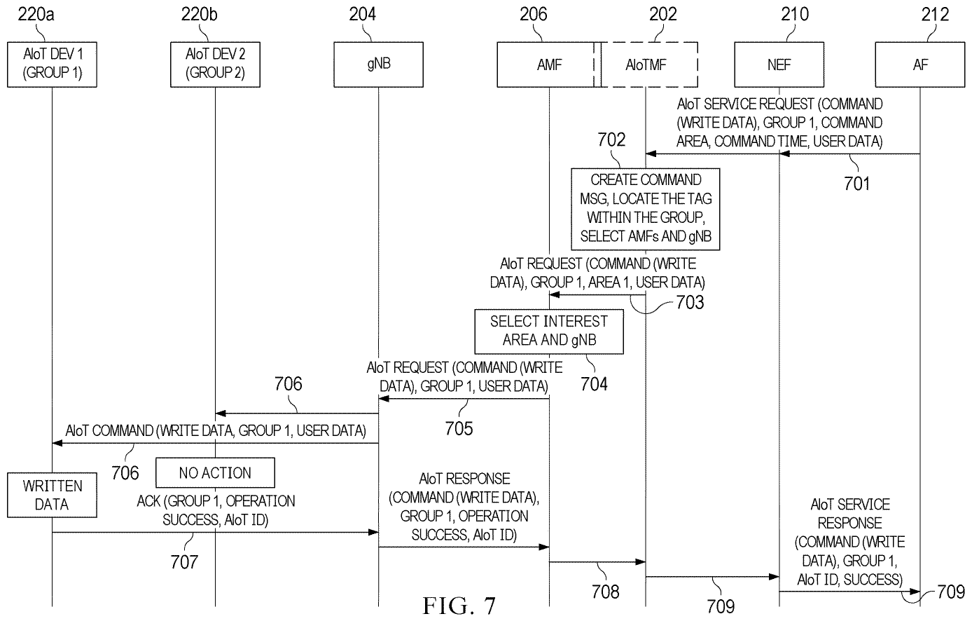

FIG. 7 shows an example flow diagram for a procedure for commanding one group of AIoT devices for a certain operation, according to some implementations.

At the operation 701, the AIoT service provider wants to re-configure (e.g., write some data into the on-board memory) all the AIoT devices belonging to group 1. So, the AIoT service provider's AF 212 sends an AIoT service request message to the AIoTMF 202 via the NEF 210, which acts as the 5G network exposure function interface to the application outside the 5G system. The AIoT service request message can include: the operation type (e.g., command type (write data)), the group operation indication, the group ID (e.g., group 1), the command operation area, the command time, and/or the user data to be written into AIoT devices. The command time information can also include frequency (periodicity) of command operation, and/or the start and end time of operation.

At the operation 702, after the AIoTMF 202 receives the AIoT service request message, the AIoTMF conducts area mapping from the operation area provided by the AF 212 to the tracking area or interested area defined within the 5G system. The AIoTMF 202 then identifies and selects the AMF(s) (e.g., AMF 206) which is(are) responsible for the command operation.

At the operation 703, when the command time starts, the AIoTMF 202 sends a 3GPP internal AIoT service request message to the selected AMF(s) (e.g., AMF 206) with a command operation type (e.g., write data), the group ID (e.g., 1), and tracking area or interested area information, and/or user data to be written into AIoT devices.

At the operation 704, the AMF 206 selects the appropriate gNB(s) (e.g., gNB 204) for the command operation area.

At the operation 705, the AMF 206 forwards the AIoT service request message to the gNB(s) (e.g., gNB 204) with operation detail information.

At the operation 706, with the command operation indication, the gNB 204 broadcasts, multicasts, or unicasts the AIoT command to the AIoT devices which belong to group 1.

The AIoT device 220b takes no action after receiving the AIoT command from gNB 204 because the AIoT device 220b does not belong to group 1. The AIoT device 220a, which belongs to group 1, conducts the write operation to write the received user data into its user memory.

At the operation 707, the AIoT device 220a, whose group ID matches with group 1 and which successfully writes the data, responds (e.g., backscatters) its ID information including status information. The gNB 204 collects the responses from group 1 AIoT devices and forwards them to the AMF. The ID information may include the same information as AIoT device identity information illustrated in FIG. 3, and the status information may be operation state 310.

At the operation 708, the AMF 206 sends the AIoT service response message to the AIoTMF 202.

At the operation 709, the AIoTMF 202 collects all the response data from the AIoT devices which belong to group 1. This may require the AIoTMF 202 to wait for a certain period of time to get all the responses. Then, the AIoTMF 202 sends the service response back to the AF 212 via the NEF 210 with the ID information of all responding AIoT devices which belong to group 1.

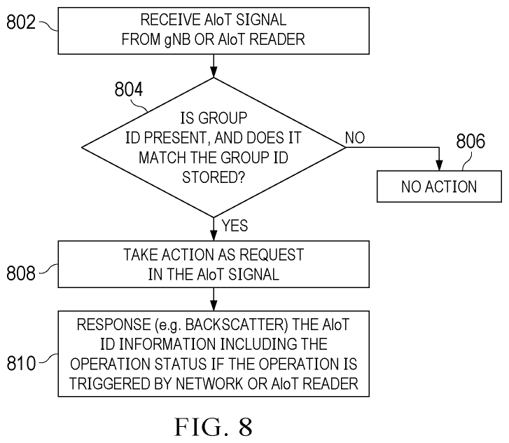

FIG. 8 shows an example flow diagram for operations performed by an AIoT device, according to some implementations. At the operation 802, the AIoT device receives an AIoT signal from a gNB or an AIoT reader. At the operation 804, the AIoT device checks whether a group identity (ID) is present and matches a stored group ID that is stored in the AIoT device. If not, the operation 806 indicates no action is taken. If there is a match, at the operation 808, the AIoT device takes action as requested in the AIoT signal. In this example, the AIoT signal includes an AIoT operation instruction and the group ID. Finally, at the operation 810, the AIoT device responds, for example via backscatter, with AIoT ID information including the operation status if the operation is triggered by the network or the AIoT reader. The process in FIG. 8 illustrates how the AIoT device handles incoming signals, determines relevance, executes actions, and provides the operational feedback.

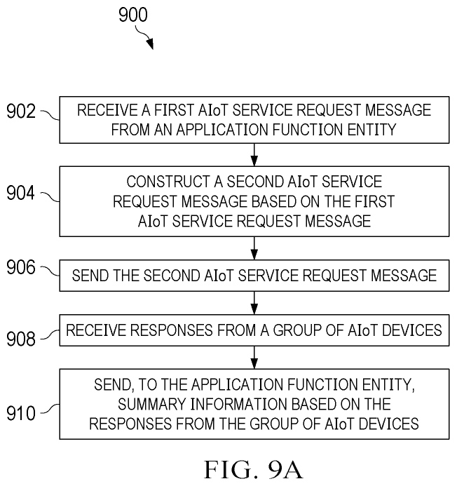

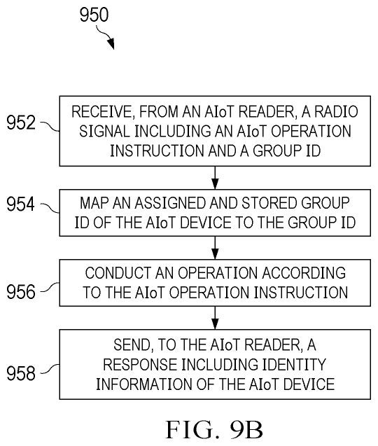

FIG. 9A shows a flow chart of a method 900 performed by a first network function entity, according to some implementations. The first network function entity may include computer-readable code or instructions executing on one or more processors of the first network function entity. Coding of the software for carrying out or performing the method 900 is well within the scope of a person of ordinary skill in the art having regard to the present disclosure. The method 900 may include additional or fewer operations than those shown and described and may be carried out or performed in a different order. Computer-readable code or instructions of the software executable by the one or more processors may be stored on a non-transitory computer-readable medium, such as for example, the memory of the first network function entity. In some implementations, the method 900 may be performed by one or more of units or modules (e.g., an integrated circuit) of the first network function entity, such as field programmable gate arrays (FPGAs) or application-specific integrated circuits (ASICs).

The method 900 starts at the operation 902, wherein the first network function entity receives a first Ambient Internet of Things (AIoT) service request message from an application function entity, according to some implementations. The first AIoT service request message includes AIoT operation type indication and group operation information. At the operation 904, the first network function entity constructs a second AIoT service request message based on the first AIoT service request message. At the operation 906, the first network function entity sends the second AIoT service request message. At the operation 908, the first network function entity receives responses from a group of AIoT devices. At the operation 910, the first network function entity sends, to the application function entity, summary information based on the responses from the group of AIoT devices.

In some implementations, the first network function entity may be a separate network function from an access management function (AMF) entity.

In some implementations, the first network function entity may send, to an AIoT reader, the second AIoT service request message.

In some implementations, the first network function entity may be a part of an AMF entity.

In some implementations, the AIoT operation type indication may indicate at least one of an AIoT data collection operation, an AIoT inventory management operation, an AIoT position operation, or an AIoT command operation.

In some implementations, the responses may include a first response from a first AIoT device of the group of AIoT devices. The first response may include first AIoT device identity information. The first AIoT device identity information may indicate at least one of a device identity (ID) of the first AIoT device, a group ID identifying the group, a network ID, a service provider ID, an AIoT dynamic ID, an AIoT device type, or an AIoT capability.

In some implementations, the responses may include a first response from a first AIoT device of the group of AIoT devices. The first response may indicate at least one of a security key or a hash compression code.

In some implementations, the first AIoT service request message may further include AIoT service request area information and AIoT service time information.

In some implementations, the AIoT service time information may further indicate at least one of a start time and an end time of an inventory query operation, a frequency of the inventory query operation, other time restriction and information associated with an AIoT service or an AIoT operation, or an aggregation waiting time for collecting responses from AIoT devices within a group for each AIoT operation.

In some implementations, the second AIoT service request message may further indicate a cell ID or a tracking area.

In some implementations, the summary information may be aggregated from the responses about a group of AIoT devices. The summary information may be sent to the application function entity in a single response message.

In some implementations, the first AIoT service request message, the second AIoT service request message, and the responses may be conveyed through an AMF using control plane management messages.

FIG. 9B shows a flow chart of a method 950 performed by an AIoT device, according to some implementations. The AIoT device may include computer-readable code or instructions executing on one or more processors of the AIoT device. Coding of the software for carrying out or performing the method 950 is well within the scope of a person of ordinary skill in the art having regard to the present disclosure. The method 950 may include additional or fewer operations than those shown and described and may be carried out or performed in a different order. Computer-readable code or instructions of the software executable by the one or more processors may be stored on a non-transitory computer-readable medium, such as for example, the memory of the AIoT device. In some implementations, the method 950 may be performed by one or more of units or modules (e.g., an integrated circuit) of the AIoT device, such as field programmable gate arrays (FPGAs) or application-specific integrated circuits (ASICs).

The method 950 starts at the operation 952, where the AIoT device receives, from an AIoT reader, a radio signal including an AIoT operation instruction and a group ID. At the operation 954, the AIoT device maps an assigned and stored group ID of the AIoT device to the group ID. At the operation 956, the AIoT device conducts an operation according to the AIoT operation instruction. At the operation 958, the AIoT device sends, to the AIoT reader, a response including identity information of the AIoT device.

In some implementations, the response may further include status information (e.g. operation state 310).

In some implementations, the AIoT operation instruction may indicate at least one of an AIoT data collection operation, an AIoT inventory management operation, an AIoT position operation, or an AIoT command operation.

In some implementations, the identity information may indicate at least one of a device identity (ID) of the AIoT device, the group ID, a network ID, a service provider ID, an AIoT dynamic ID, an AIoT device type, or an AIoT capability.

In some implementations, the response may indicate at least one of a security key or a hash compression code.

The following references are incorporated in this disclosure by reference:
TR22.840 (v0.4.0): Study on Ambient power-enabled Internet of Things
EPC™ Radio-Frequency Identity Protocols Generation-2 UHF RFID version 2.0.1
TR38.848: Study on Ambient IoT (Internet of Things) in RAN
EPC Tag Data Standard (TDS).

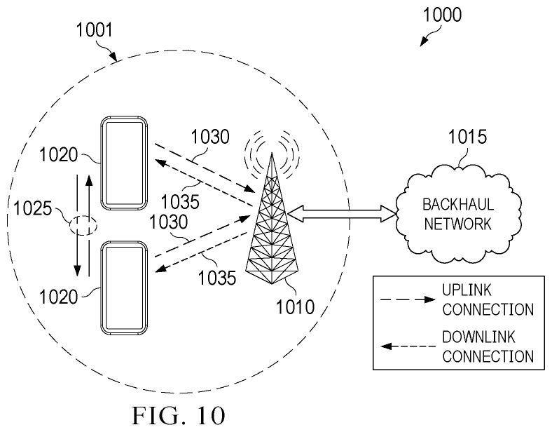

FIG. 10 illustrates an example communications system 1000, according to some implementations. Communications system 1000 includes an access node 1010 serving user equipments (UEs) with coverage 1001, such as UEs 1020. In a first operating mode, communications to and from a UE passes through access node 1010 with a coverage area 1001. The access node 1010 is connected to a backhaul network 1015 for connecting to the internet, operations and management, and so forth. In a second operating mode, communications to and from a UE do not pass through access node 1010, however, access node 1010 typically allocates resources used by the UE to communicate when specific conditions are met. Communications between a pair of UEs 1020 can use a sidelink connection (shown as two separate one-way connections 1025). In FIG. 10, the sideline communication is occurring between two UEs operating inside of coverage area 1001. However, sidelink communications, in general, can occur when UEs 1020 are both outside coverage area 1001, both inside coverage area 1001, or one inside and the other outside coverage area 1001. Communication between a UE and access node pair occur over uni-directional communication links, where the communication links between the UE and the access node are referred to as uplinks 1030, and the communication links between the access node and UE is referred to as downlinks 1035.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

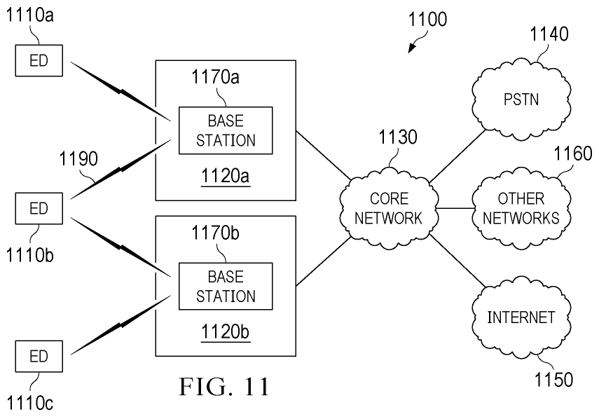

FIG. 11 illustrates an example communication system 1100, according to some implementations. In general, the system 1100 enables multiple wireless or wired users to transmit and receive data and other content. The system 1100 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1100 includes electronic devices (ED) 1110a-1110c, radio access networks (RANs) 1120a-1120b, a core network 1130, a public switched telephone network (PSTN) 1140, the Internet 1150, and other networks 1160. While certain numbers of these components or elements are shown in FIG. 11, any number of these components or elements may be included in the system 1100.

The EDs 1110a-1110c are configured to operate or communicate in the system 1100. For example, the EDs 1110a-1110c are configured to transmit or receive via wireless or wired communication channels. Each ED 1110a-1110c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1120a-1120b here include base stations 1170a-1170b, respectively. Each base station 1170a-1170b is configured to wirelessly interface with one or more of the EDs 1110a-1110c to enable access to the core network 1130, the PSTN 1140, the Internet 1150, or the other networks 1160. For example, the base stations 1170a-1170b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1110a-1110c are configured to interface and communicate with the Internet 1150 and may access the core network 1130, the PSTN 1140, or the other networks 1160.

In the embodiment shown in FIG. 11, the base station 1170a forms part of the RAN 1120a, which may include other base stations, elements, or devices. Also, the base station 1170b forms part of the RAN 1120b, which may include other base stations, elements, or devices. Each base station 1170a-1170b operates to transmit or receive wireless signals within a particular geographic region or area, sometimes referred to as a “cell.” In some embodiments, multiple-input multiple-output (MIMO) technology may be employed having multiple transceivers for each cell.

The base stations 1170a-1170b communicate with one or more of the EDs 1110a-1110c over one or more air interfaces 1190 using wireless communication links. The air interfaces 1190 may utilize any suitable radio access technology.

It is contemplated that the system 1100 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1120a-1120b are in communication with the core network 1130 to provide the EDs 1110a-1110c with voice, data, application, Voice over Internet Protocol (VoIP), or other services. Understandably, the RANs 1120a-1120b or the core network 1130 may be in direct or indirect communication with one or more other RANs (not shown). The core network 1130 may also serve as a gateway access for other networks (such as the PSTN 1140, the Internet 1150, and the other networks 1160). In addition, some or all of the EDs 1110a-1110c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1150.

Although FIG. 11 illustrates one example of a communication system, various changes may be made to FIG. 11. For example, the communication system 1100 could include any number of EDs, base stations, networks, or other components in any suitable configuration.

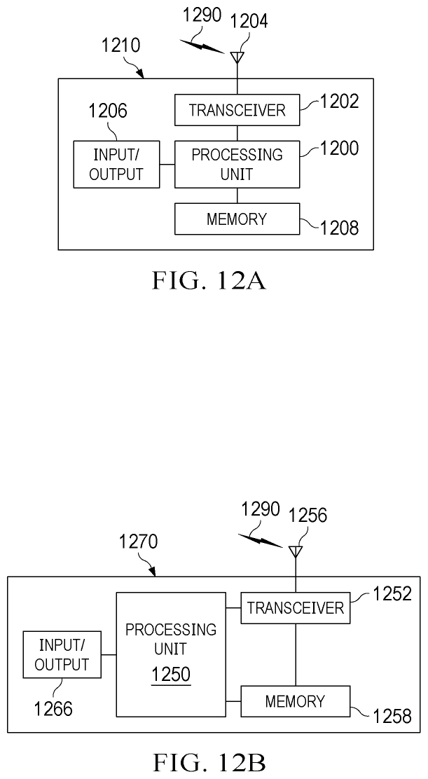

FIGS. 12A and 12B illustrate example devices that may implement the methods and teachings of this disclosure, according to some implementations. In particular, FIG. 12A illustrates an example ED 1210, and FIG. 12B illustrates an example base station 1270. These components could be used in the system 1100 or in any other suitable system.

As shown in FIG. 12A, the ED 1210 includes at least one processing unit 1200. The processing unit 1200 implements various processing operations of the ED 1210. For example, the processing unit 1200 could perform signal coding, data processing, power control, input/output processing, or any other functionality enabling the ED 1210 to operate in the system 1100. The processing unit 1200 also supports the methods and teachings described in more detail above. Each processing unit 1200 includes any suitable processing or computing device configured to perform one or more operations. Each processing unit 1200 could, for example, include a microprocessor, microcontroller, digital signal processor, field programmable gate array, or application specific integrated circuit.

The ED 1210 also includes at least one transceiver 1202. The transceiver 1202 is configured to modulate data or other content for transmission by at least one antenna or NIC (Network Interface Controller) 1204. The transceiver 1202 is also configured to demodulate data or other content received by the at least one antenna 1204. Each transceiver 1202 includes any suitable structure for generating signals for wireless or wired transmission or processing signals received wirelessly or by wire. Each antenna 1204 includes any suitable structure for transmitting or receiving wireless or wired signals. One or multiple transceivers 1202 could be used in the ED 1210, and one or multiple antennas 1204 could be used in the ED 1210. Although shown as a single functional unit, a transceiver 1202 could also be implemented using at least one transmitter and at least one separate receiver.

The ED 1210 further includes one or more input/output devices 1206 or interfaces (such as a wired interface to the Internet 1150). The input/output devices 1206 facilitate interaction with a user or other devices (network communications) in the network. Each input/output device 1206 includes any suitable structure for providing information to or receiving information from a user, such as a speaker, microphone, keypad, keyboard, display, or touch screen, including network interface communications.

In addition, the ED 1210 includes at least one memory 1208. The memory 1208 stores instructions and data used, generated, or collected by the ED 1210. For example, the memory 1208 could store software or firmware instructions executed by the processing unit(s) 1200 and data used to reduce or eliminate interference in incoming signals. Each memory 1208 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 12B, the base station 1270 includes at least one processing unit 1250, at least one transceiver 1252, which includes functionality for a transmitter and a receiver, one or more antennas 1256, at least one memory 1258, and one or more input/output devices or interfaces 1266. A scheduler, which would be understood by one skilled in the art, is coupled to the processing unit 1250. The scheduler could be included within or operated separately from the base station 1270. The processing unit 1250 implements various processing operations of the base station 1270, such as signal coding, data processing, power control, input/output processing, or any other functionality. The processing unit 1250 can also support the methods and teachings described in more detail above. Each processing unit 1250 includes any suitable processing or computing device configured to perform one or more operations. Each processing unit 1250 could, for example, include a microprocessor, microcontroller, digital signal processor, field programmable gate array, or application specific integrated circuit.

Each transceiver 1252 includes any suitable structure for generating signals for wireless or wired transmission to one or more EDs or other devices. Each transceiver 1252 further includes any suitable structure for processing signals received wirelessly or by wire from one or more EDs or other devices. Although shown combined as a transceiver 1252, a transmitter and a receiver could be separate components. Each antenna 1256 includes any suitable structure for transmitting or receiving wireless or wired signals. While a common antenna 1256 is shown here as being coupled to the transceiver 1252, one or more antennas 1256 could be coupled to the transceiver(s) 1252, allowing separate antennas 1256 to be coupled to the transmitter and the receiver if equipped as separate components. Each memory 1258 includes any suitable volatile or non-volatile storage and retrieval device(s). Each input/output device 1266 facilitates interaction with a user or other devices (network communications) in the network. Each input/output device 1266 includes any suitable structure for providing information to or receiving/providing information from a user, including network interface communications.

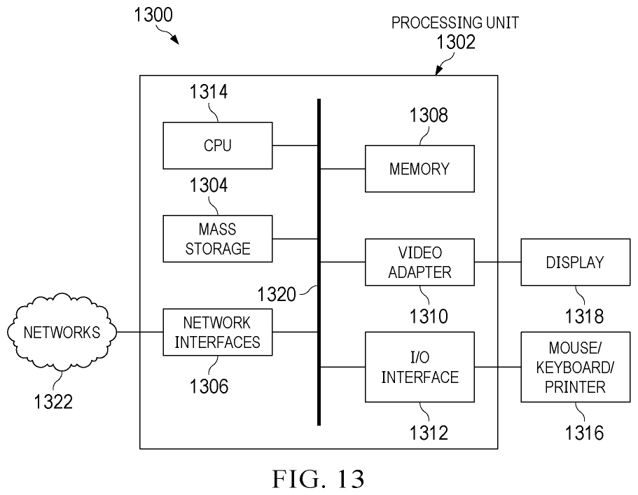

FIG. 13 is a block diagram of a computing system 1300 that may be used for implementing the devices and methods disclosed herein, according to some implementations. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1300 includes a processing unit 1302. The processing unit includes a central processing unit (CPU) 1314, memory 1308, and may further include a mass storage device 1304, a video adapter 1310, and an I/O interface 1312 connected to a bus 1320.

The bus 1320 may be one or more of any type of several bus architectures including a memory bus or memory controller, a peripheral bus, or a video bus. The CPU 1314 may comprise any type of electronic data processor. The memory 1308 may comprise any type of non-transitory system memory such as static random access memory (SRAM), dynamic random access memory (DRAM), synchronous DRAM (SDRAM), read-only memory (ROM), or a combination thereof. In an embodiment, the memory 1308 may include ROM for use at boot-up, and DRAM for program and data storage for use while executing programs.

The mass storage 1304 may comprise any type of non-transitory storage device configured to store data, programs, and other information and to make the data, programs, and other information accessible via the bus 1320. The mass storage 1304 may comprise, for example, one or more of a solid state drive, hard disk drive, a magnetic disk drive, or an optical disk drive.

The video adapter 1310 and the I/O interface 1312 provide interfaces to couple external input and output devices to the processing unit 1302. As illustrated, examples of input and output devices include a display 1318 coupled to the video adapter 1310 and a mouse, keyboard, or printer 1316 coupled to the I/O interface 1312. Other devices may be coupled to the processing unit 1302, and additional or fewer interface cards may be utilized. For example, a serial interface such as Universal Serial Bus (USB) (not shown) may be used to provide an interface for an external device.

The processing unit 1302 also includes one or more network interfaces 1306, which may comprise wired links, such as an Ethernet cable, or wireless links to access nodes or different networks. The network interfaces 1306 allow the processing unit 1302 to communicate with remote units via the networks. For example, the network interfaces 1306 may provide wireless communication via one or more transmitters/transmit antennas and one or more receivers/receive antennas. In an embodiment, the processing unit 1302 is coupled to a local-area network 1322 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method, comprising:
receiving, by a first network function entity, a first Ambient Internet of Things (AIoT) service request message from an application function entity, the first AIoT service request message including AIoT operation type indication and group operation indication;
constructing, by the first network function entity, a second AIoT service request message based on the first AIoT service request message;
sending, by the first network function entity, the second AIoT service request message;
receiving, by the first network function entity, one or more responses from a group of AIoT devices; and
sending, by the first network function entity to the application function entity, summary information based on the one or more responses from the group of AIoT devices.

2. The method of claim 1, wherein the first network function entity is a separate network function from an access management function (AMF) entity.

3. The method of claim 2, the sending the second AIoT service request message comprising:
sending, by the first network function entity to an AIoT reader, the second AIoT service request message.

4. The method of claim 1, the AIoT operation type indication indicating at least one of an AIoT data collection operation, an AIoT inventory management operation, an AIoT position operation, or an AIoT command operation.

5. The method of claim 1, the one or more responses including a first response from a first AIoT device of the group of AIoT devices, the first response including first AIoT device identity information, the first AIoT device identity information indicating at least one of a device identity (ID) of the first AIoT device, a group ID identifying the group, a network ID, a service provider ID, an AIoT dynamic ID, an AIoT device type, or an AIoT capability.

6. The method of claim 5, the group ID being in a format of filtering associated with different filtering elements, each filtering element of the different filtering elements corresponds to a corresponding component of the first AIoT device to identify or filter one or more AIoT devices, the corresponding component including at least one of an identifier type, a public line mobile network (PLMN) identifier, or a third party identifier or identification information.

7. The method of claim 1, the one or more responses including a first response from a first AIoT device of the group of AIoT devices, the first response indicating at least one of a security key or a hash compression code.

8. The method of claim 1, the first AIoT service request message further including AIoT service request area information and AIoT service time information.

9. The method of claim 8, the AIoT service time information further indicating at least one of a start time and an end time of an inventory query operation, a frequency of the inventory query operation, other time restriction and information associated with an AIoT service or an AIoT operation, or an aggregation time for collecting responses from the group of AIoT devices within a group for each AIoT operation.

10. The method of claim 9, the aggregation time is a fixed time interval for which a second network entity or an AIoT reader to collects the responses from the AIoT devices before reporting an aggregated AIoT response.

11. The method of claim 1, the second AIoT service request message further indicating a cell identity (ID) or an AIoT service area.

12. The method of claim 1, wherein the summary information is aggregated from a plurality of responses about the group of AIoT devices, and the summary information is sent to the application function entity in a single response message.

13. The method of claim 1, wherein the first AIoT service request message, the second AIoT service request message, and the one or more responses are conveyed using control plane management messages.

14. A method, comprising:
receiving, by an Ambient Internet of Things (AIoT) device from an AIoT reader, a radio signal including an AIoT operation instruction and a group identity (ID);
mapping, by the AIoT device, the group ID to a stored group ID in the AIoT device;
conducting, by the AIoT device in response to the mapping, an operation according to the AIoT operation instruction; and
sending, by the AIoT device to the AIoT reader, a response including identity information of the AIoT device.

15. The method of claim 14, the response further including status information.

16. The method of claim 14, the group ID being in a format of filtering associated with different filtering elements, each filtering element of the different filtering elements corresponds to a corresponding component of the AIoT device to identify or filter one or more AIoT devices, the corresponding component including at least one of an identifier type, a public line mobile network (PLMN) identifier, or a third party identifier or identification information.

17. The method of claim 14, the AIoT operation instruction indicating at least one of an AIoT data collection operation, an AIoT inventory management operation, an AIoT position operation, or an AIoT command operation.

18. The method of claim 14, the identity information indicating at least one of a device identity (ID) of the AIoT device, the group ID, a network ID, a service provider ID, an AIoT dynamic ID, an AIoT device type, or an AIoT capability.

19. The method of claim 14, the response indicating at least one of a security key or a hash compression code.

20. A first network function entity, comprising:
at least one processor; and
a non-transitory computer readable storage medium storing programming, the programming including instructions that, when executed by the at least one processor, cause the first network function entity to perform:
receiving a first Ambient Internet of Things (AIoT) service request message from an application function entity, the first AIoT service request message including AIoT operation type indication and group operation indication;
constructing a second AIoT service request message based on the first AIoT service request message;
sending the second AIoT service request message;
receiving one or more responses from a group of AIoT devices; and
sending, to the application function entity, summary information based on the one or more responses from the group of AIoT devices.

21. An Ambient Internet of Things (AIoT) device, comprising:
at least one processor; and
a non-transitory computer readable storage medium storing programming, the programming including instructions that, when executed by the at least one processor, cause the AIoT device to perform:
receiving, from an AIoT reader, a radio signal including an AIoT operation instruction and a group identity (ID);
mapping the group ID to a stored group ID in the AIoT device;
conducting, in response to the mapping, an operation according to the AIoT operation instruction; and
sending, to the AIoT reader, a response including identity information of the AIoT device.

22. The AIoT device of claim 21, the response further including status information.
